(19) United States
(12) Patent Application Publication
(10) Pub. No.: US 2019/0284366 A1
(43) Pub. Date: Sep. 19, 2019

(54) EXOTHERM STOPPER MIXTURES

(71) Applicant: KORDSA TEKNIK TEKSTIL ANONIM SIRKETI, Kocaeli (TR)

(72) Inventors: Cem OZTURK, Istanbul (TR); Selim, H KUSEFOGLU, Istanbul (TR)

(73) Assignee: KORDSA TEKNIK TEKSTIL ANONIM SIRKETI, Kocaeli (TR)

(21) Appl. No.: 16/301,449

(22) PCT Filed: Oct. 27, 2016
(86) PCT No.: PCT/EP2016/075963

§ 371 Date: Nov. 14, 2018

(51) Int. Cl. C08K 5/09; C08G 59/50; C08G 59/42; C08K 5/43

(52) U.S. Cl. CPC C08K 5/09; C08G 59/50; C08K 5/0058; C08K 5/43; C08G 59/42

(57) ABSTRACT

An exotherm stopper mixture for controlling the exotherm between epoxy-amine thermosetting resins and a hardener, comprising water, at least one high-boiling solvent, at least one exothermicity stopping reactant, and an excipient mixture comprising a surfactant, an emulsifier, a disperser, a co-solvent or a combination thereof.

### CROSS REFERENCE TO RELATED APPLICATIONS

This application is the national phase entry of International Application No. PCT/EP2016/075963, filed on Oct. 27, 2016, the entire contents of which are incorporated herein by reference.

### TECHNICAL FIELD

Present invention is related with exotherm that causing toxic emissions, excessive temperature rising, flame and the resin to adhere to a temporary storage tank.

Present invention is also related with an exotherm stopper mixture specific to resin type that stops the exotherm, reduce the emission and help cleaning to be done after the reaction.

### BACKGROUND

An exotherm is an uncontrollable reaction between a solvent-free resin and hardener, which happens when the heat generated by the resin-hardener reaction cannot escape readily. The trapped heat accelerates the reaction, which in turn generates more heat and further accelerates the reaction until it becomes uncontrollable. For every 10° C. rise in temperature the reaction rate doubles. This normally happens only in bulk mixes, as mixed resin applied to a job is usually in a thin film from which heat readily escapes. Therefore, care should be taken to control excessive exotherm, which can result in overheating of the product and possible thermal decomposition.

There are several factors that can affect the degree of exotherm produced like the volume and configuration of the mixed mass, the temperature of the mixture, the formation of concentrated regions because of not using the mixed materials quickly enough, the reactivity of the epoxy thermosetting resin and the curing agent.

As uncontrolled rise in the temperature causes some severe results, precautions should be taken. First of all the mixture is actively heated and cooled in order to control the temperature. Activity of the epoxy thermosetting resin curing agent that is used should be as low as possible. Also, preparing the smaller amount of the mixture than critical mass of mixture is another way to prevent or slow down to exotherm. Finally, the mixture can be prepared at the possible lowest temperature.

Polymerization reactions are subject to the Arrhenius equation [1] as every reaction. In every reaction rate constant (k) depends on the temperature

k=Ae^{-Ea/RT} [1]

Ea: activation energy

R: Universal gas constant

T: absolute Temperature

A: is the pre-exponential factor (or simply the pre-factor)

k: rate constant of a chemical reaction

At temperature (T) energy of the molecules are distributed by Boltzmann distribution. Thus, collisions with higher energy than activation energy are proportional to e−Ea/RT.

All the values except the temperature (T) are constant in Arrhenius equation. Every 10° C. increase in the temperature increases rate constant approximately 2 times or more.

As the polymerization reactions come close to end, an increase is observed not only in viscosity but also in temperature. Every 10° C. rise in temperature doubles the speed of reaction and causes increased heat discharge. Gelled polymer also slows down the termination reactions in free radical reactions. Increase in heat becomes uncontrollable because of the increase in the overall rate of reaction. This phenomenon is called Trommsdorff-Norrish effect in free radical polymerizations, step-growth polymerization in epoxy-amine polymerizations and uncontrolled exotherm in condensation reactions.

Reaction rate of radical reactions shown by the following equation [2]:

I: molarity of free radical initiator

M: molarity of monomer

P: Polymer

$$Rate = {{kp ( \frac{fkd}{kt} )}^{1 / 2} [ I ]}^{1 / 2} [ M ] \qquad [ 2 ]$$

Activated monomers, free radical initiators, chain growing oligomers are quenched. Thus, reaction speed slows down and after a while reaction stops.

Reaction rate of epoxy-amine and more of the same polymerization reactions (step-growth) shown by the following equation [3];

Epoxy+Amine→P

Rate=k[Epoxy][Amine] [3]

Epoxy: Molarity of the epoxy group

Amine: Molarity of the amine group

Stopping the exotherm by pouring water or sand is the main method in the prior art. It is also known from US2004181016 A and US2015045521 A that exotherm can be terminated by poisoned the catalyst used in the olefin polymerization reactions by chemically reactive agents. US2004253151 A, US2010317812 A and US2005246067 A disclose a method of termination of the exotherm by injecting a kill agent automatically when an increase in pressure in the reaction vessel is sensed.

It is also known in the prior art that protonation of amines by HCl is a method used to stop polymerization and to prevent the cross linking of the epoxy amine reactions. U.S. Pat. No. 3,346,519 A disclose the synthesis of cationic epoxy-amine derivatives that are soluble and dispersible.

It should be noted that the methods in the prior art are not enough to stop exotherms or reduced their effects. It is not guaranteed to stop exotherm by using the methods in the prior art like pouring water or sand. Moreover, these methods do not help or contribute for cleaning after the reaction or they do not decrease the emission. The resulting emissions are carcinogenic in most cases. If the emission is not prevented or reduced or causes some temporary or permanent effects on health.

### SUMMARY

Present invention discloses an exotherm stopper mixture suitable for being used to control the exotherm between a resin and a hardener comprises water, at least one high-boiling solvent, at least one exotherm stopper reactive and an excipient mixture comprising surfactant, emulsifier, disperser or co-solvent or combination thereof. Present invention also discloses a method of controlling exotherm between a resin and a hardener, characterized in that the exotherm stopper mixture is added to thermosetting resin such that the exotherm stopper mixture is at least twice the volume of resin that forms exotherm.

One of the objects of the present invention is to provide an exotherm stopper mixture that has high boiling point and low vapor pressure.

One of the objects of the invention is to provide an exotherm stopper mixture formulation to make easier to clean the medium of the reaction between resin and hardener.

Another object of the invention is to provide an exotherm stopper mixture that reduces the carcinogenic emission resulted from the reaction between resin and hardener.

One of the objects of the invention is to provide a method to prevent the reaction between resin and hardener.

### DETAILED DESCRIPTION OF THE EMBODIMENTS

When the heat generated by the resin-hardener reaction cannot escape readily, exotherm, which is an uncontrollable reaction between a resin and hardener, occurs. Exotherm causes toxic emissions, excessive temperature rising, flame and the resin to adhere to a temporary storage tank. Preventing exotherm by cooling the reaction with water or sand is a known method in the prior art. When temperature rise is stopped by sand or water, it causes to slow down exotherm but this method is limited because thermosetting resins are often good heat insulators and water or sand cannot reach the center of the exotherm. This method is effective only on the exterior surface. Also, this method does not stop the reaction or occurring of the exotherm by binding the catalyst or chemicals that causes the reaction. Present invention provides an exotherm stopper mixtures suitable for being used to control the exotherm between a resin and a hardener and its side effects like carcinogenic emission. Present invention provides a method of controlling exotherm between a resin and a hardener that the exotherm stopper mixture is added to thermosetting resin such that the exotherm stopper mixture is at least twice the volume of resin that forms exotherm. The term of exotherm stopper is a mixture that binds with amine groups to terminate the exothermic reaction. When all the amine groups are consumed, the reaction between resin and hardener stops.

By adding these stopper mixtures to the reaction medium or vessel, it is not only prevented the uncontrollable reaction between a resin and hardener but also these mixtures make easier to clean the reaction vessels after reaction is completed. When thermosetting resins are emulsified with excipient mixture comprising surfactants, emulsifiers, dispersants or co-solvents or combination thereof in the exotherm stopper mixture, resins absorb solvents. In this way, cleaning to be done become much easier than the methods in the prior art. For instance, when sand is added to the reaction medium, viscosity increases excessively and it makes difficult to cleaning.

An exotherm stopper mixture disclosed in the present invention suitable for being used to control the exotherm between an epoxy-amine resin and a hardener comprises water; at least one high-boiling solvent whose boiling point is greater than 100° C. selected from the group comprising N-Methyl pyrrolidone (NMP), Diethylene Glycol, Xylene, Dimethyl formamide (DMF), Dimethyl acetamide (DMAc) and/or Dimethyl sulfoxide (DMSO) or combinations thereof; at least one exotherm stopper reactive that forms radical initiators and radical forms by bonding to curing agent in the resin and intermediate structures formed by the curing agent and resin, selected from the group comprising sulphamic acid, KOH, caprolactam BHT, hydroquinone and/or ascorbic acid or combinations thereof and an excipient mixture comprising surfactant, emulsifier, disperser or co-solvent or combination thereof.

Exotherm stopper mixtures are prepared for the thermosetting resin type. These types are preferably the thermosetting resins that give double bond polymerization reactions, thermosetting resins that give polyurethane and polyurea reactions, epoxy-amine thermosetting resins and epoxy anhydride thermosetting resins.

Water and high-boiling solvents in exotherm stopper mixtures is used to reduce exotherm temperature and solving the resin. There are no other solvent can replace water. The water requirement is different for each polymer system. Also, high-boiling solvents disclosed in the present invention are the solvents that have a boiling point greater than or equal to 100° C.

In one preferred embodiment of the invention, exotherm stopper mixtures suitable for being used to control the exotherm between a resin and a hardener preferably comprise 20-30%, 20-40%, 5-15% and 10-30% of water for epoxy-amine thermosetting resin, epoxy-anhydride thermosetting resin, thermosetting resins giving double bond polymerizations and thermosetting resins giving polyurethane and polyurea reactions, respectively.

In one other preferred embodiment of the invention exotherm stopper mixtures suitable for being used to control the exotherm between a resin and a hardener preferably comprise 20-30%, 50-60%, 50-80% and 20-40% of high-boiling solvent for epoxy-amine thermosetting resin, epoxy-anhydride thermosetting resin, thermosetting resins giving double bond polymerizations and thermosetting resins giving polyurethane and polyurea reactions, respectively.

Exotherm stopper mixture suitable for being used to control the exotherm between a resin and a hardener comprises at least one high-boiling solvent selected from the group NMP (N-Methyl pyrrolidone), Diethylene Glycol, Xylene, DMF (Dimethyl formamide), DMAc (Dimethyl acetamide) and/or DMSO (Dimethyl sulfoxide). High-boiling solvents must comply with the polarity of the polymer. The most preferred solvent is/or diethylene glycol. The required amount of solvent in an exotherm stopper mixture depend the type of resin. Diethylene glycol is preferred high-boiling solvent reactive for epoxy-amine reaction. Diethylene glycol and/or NMP are preferred high-boiling solvent for epoxy-anhydride reactions and for thermosetting resins giving polyurethane and polyurea reactions. Diethylene glycol, xylene and/or NMP are preferred high-boiling solvent for thermosetting resins that give double bond polymerization reaction.

Exotherm stopper mixture suitable for being used to control the exotherm between a resin and a hardener disclosed in the present invention also comprises an excipient mixture comprising surfactant, emulsifier, disperser or co-solvent or combination thereof. excipient mixture is added to the exotherm stopper mixture suitable for being used to control the exotherm between a resin and a hardener in order to emulsify the resin mixture in water and solvent, to aid mixing of water with solvents, dispersing exothermic resin in solvent so that transfer the heat of reaction to solvent thus further slowing the reaction rate, to aid cleaning of reaction vessel after exotherm stopping finished. Surfactants, emulsifiers, dispersants and co-solvents in excipient mixture are chosen for their performance in dispersing resin and its monomers in water and solvents. pH of exotherm stopper mixture dictates the use of anionic or cationic surfactant use, non-ionic surfactants are also used. Amount of surfactant needed in exotherm stopper mixture is calculated according to HLB and ratio of monomer/polymers in resin to solvent/water in exotherm stopper.

In another preferred embodiment of the invention, exotherm stopper mixtures suitable for being used to control the exotherm between a resin and a hardener preferably comprise in the mixture is 5-15%, 3-10%, 10-20% and 5-15% of excipient mixture comprising surfactant, emulsifier, disperser or co-solvent or combination thereof for epoxy-amine thermosetting resin, epoxy-anhydride thermosetting resin, thermosetting resins giving double bond polymerizations and thermosetting resins giving polyurethane and polyurea reactions respectively.

Exotherm stopper mixtures suitable for being used to control the exotherm between a resin and a hardener comprise excipient mixture comprising surfactant, emulsifier, disperser or co-solvent or combination thereof preferable selected from the group; cetrimonium chloride, bis-(2 hydroxyethyl) tallow alkyl amine oxide, cocamide propyl betaine, C10-16 Alkyl polyglycoside, C12/15 8 EO, sorbitan monolaurate (S20), sodium lauryl sarcosinate, 1-Decanol and imidazoline 18 OH. Cetrimonium Chloride, bis-(2 hydroxyethyl) tallow alkyl amine oxide and/or Cocamide propyl betaine is preferred excipient mixture for epoxy-amine thermosetting resins. C10-16 alkyl polyglycoside and/or C12/15 8 EO are preferred excipient mixture epoxy-anhydride thermosetting resins. sorbitan monolaurate (S20), Sodium Lauryl Sarcosinate, 1-Decanol, C12/15 8 EO and imidazoline 18 OH are preferred excipient mixture for both thermosetting resins that give double bond polymerization reactions and thermosetting resins that give polyurethane and polyurea reactions.

Role of the surfactant in excipient mixture is making water-solvent mixture/emulsion to penetrate the semi-cured resin or in the beginning of exotherm thanks to low amount of crosslinks dissolving the resin in solvent/water mixture. Thus, they facilitate heat transfer to the solvent/water mixture and penetration of active ingredients to the resin. Surfactant in excipient mixture is preferably is hard-duty surfactant.

Exotherm stopper mixtures suitable for being used to control the exotherm between a resin and a hardener preferably comprise at least one exotherm stopper reactive. As it can be understood from the name exotherm stopper reactive are used to prevent the reaction forming exotherm. The reactive in the exotherm stopper mixture, curing agent in the resin and intermediate structures formed by the curing agent and resin are bonded and form radical initiators and radical forms. Because of this chemical bonding, exotherm is permanently stopped; resin components became more compatible with solvent. Another reason to use them is to facilitate the dissolution in water and solvent. Also they reduce the cross link amount while they stop exotherm. Thus, they help dissolution and make cleaning much more easily. Exotherm stopper reactive are preferred liquid form. The amount of exotherm stopper reactive should be provided such that it will be at least twice the maximum concentration of monomer and polymer that they can bond to. Exotherm stopper reactive is specific to each polymerization system.

In another preferred embodiment of the invention, exotherm stopper mixtures preferably comprise 30-45%, 5-15%, 10-20%, 30-50% of exotherm stopper reactive for epoxy-amine thermosetting resin, epoxy-anhydride thermosetting resin, thermosetting resins giving double bond polymerizations and thermosetting resins giving polyurethane and polyurea reactions respectively.

Exotherm stopper mixtures suitable for being used to control the exotherm between a resin and a hardener comprise at least one exotherm stopper reactive selected from the group acetic acid, sulphamic acid, KOH, caprolactam BHT, hydroquinone and/or ascorbic acid. Acetic acid and/or sulphamic acid are preferred exotherm stopper reactive for epoxy-amine reaction. Caustic (KOH) is preferred exotherm stopper reactive for epoxy-anhydride reactions. BHT (Butylated hydroxyl toluene), hydroquinone and/or ascorbic acid are preferred exotherm stopper reactive for thermosetting resins that give double bond polymerization reaction. Caprolactam is preferred exotherm stopper reactive for thermosetting resins giving polyurethane and polyurea reactions.

In a preferred embodiment of the invention, exotherm stopper mixtures preferably comprise an antimicrobial agent to increase the shelf life by preventing infection of bacteria, fungi and other biomass contaminants. Exotherm stopper mixtures preferably comprise 0-5% of antimicrobial agent for each type of resin.

TABLE 1
Percentages of main components in exotherm stopper mixtures depending on
thermosetting resin type

| | | Epoxy | Thermosetting Resins | Resins That Give |
|---|---|---|---|---|
| | Epoxy-Amine | Thermosetting | That Give Double | Polyurethane |
| | Thermosetting | Anhydride | Bond Polymerization | And Polyurea |
| Substance | Resin | Resin | Reactions | Reactions |
| Water | 20 < x < 30% | 20 < x < 40% | 5 < x < 15% | 30 < x < 70% |
| High-Boiling | 20 < x < 30% | 50 < x < 60% | 50 < x < 80% | 20 < x < 40% |
| Solvents | | | | |
| Excipient | 5 < x < 15% | 3 < x < 10% | 10 < x < 20% | 5 < x < 15% |
| Mixture | | | | |
| Exotherm stopper | 30 < x < 45% | 5 < x < 15% | 10 < x < 20% | 30 < x < 50% |
| reactive | | | | |
| Antimicrobials | 0 < x < 5% | 0 < x < 5% | 0 < x < 5% | 0 < x < 5% |

Exotherm stopper mixtures are investigated based on four different resin types. The results obtained in this investigation are described below.

Sample 1 is directed to understand the effect of exotherm stopper mixture on epoxy-amine thermosetting resins. This exotherm stopper mixtures preferably comprises acetic acid and sulphamic acid as exotherm stopper reactive. Acetic acid gives a reaction with high-boiling amines that bind the amines in thermosetting resins and amines formed by the reaction. High-boiling amines are the amines that have a boiling point greater than or equal to 100° C.

Sulphamic acid also make easier to cleaning of reaction vessel. Excipient mixture comprising surfactants, emulsifiers, dispersants or co-solvents or combination thereof are used to keep hydrophilic and lipophilic substances in the mixture together. They are also used to disperse quarternized amines in water and solvent during exotherm stopping reaction. Cetrimonium Chloride, Bis-(2 hydroxyethyl) tallow alkyl amine oxide and Cocamide propyl betaine are used alone or in combination to form excipient mixture Water and diethylene glycol are preferred high-boiling solvent and they are capable of solving the resin are added in order to cool the exotherm, solve the resin and aid to clean.

Substances used in the sample 1, CAS numbers and trade names and sources are given in Table 2. All chemicals are mixed in the order of table with a laboratory type mixer at 400 rpm. The mixture is stirred 5-30 minutes, preferably 15 minutes, in 20 L. polyethylene or glass in a container. After preparing the mixture, it is stored in 15 L closed high density polyethylene (HDPE) container, stainless steel container or any other suitable container. Exotherm stopper mixture should not dissolve or react with the chemicals in vessel structure. The amount of exotherm stopper mixture should be provided such that it will be at least twice the volume of thermosetting resin that may form exotherm. All samples disclosed in the present invention are prepared by the same method. Table 2 shows exotherm stopper mixture specified for epoxy-amine thermosetting resins.

TABLE 2
1^{st} sample of exotherm stopper mixture specified for epoxy-amine thermosetting resins

| | | | | Definition | | Brand |
|---|---|---|---|---|---|---|
| | | | | and ideal | | Name |
| Percentage | Weight (g) | Volume (ml) | Substance | amounts | CAS | Supplier |
| 39% | 3900 | 3714 | Acetic Acid | Exotherm | 64-19-7 | Acetic acid |
| | | | | Stopper | | (glacial) |
| | | | | reactive, | | 100% |
| | | | | 30 < x < 45% | | Merck |
| | | | | | | Millipore |
| 2% | 200 | 93 | Sulphamic | | 5329- | SIGMA- |
| | | | acid | | 14-6 | ALDRICH |
| | | | | | | Sulfamic |
| | | | | | | acid |
| | | | | | | analytical |
| | | | | | | standard |
| | | | | | | (for |
| | | | | | | acidimetry), |
| | | | | | | ACS |
| | | | | | | reagent |
| 27% | 2700 | 2411 | Diethylene | High- | 111-46-6 | SIGMA- |
| | | | Glycol | Boiling | | ALDRICH |
| | | | | Solvents | | Diethylene |
| | | | | 20 < x < 30% | | glycol |
| | | | | | | ReagentPlus ®, |
| | | | | | | 99% |
| 22% | 2200 | 2200 | Water | Water | | Deionized |
| | | | | 20 < x < 30% | | |
| 4% | 400 | 348 | Cetrimonium | excipient | 112-02-7 | VARISOFT ® |
| | | | Chloride | mixture | | 300 |
| | | | | 5 < x < 15% | | Evonik |
| | | | | | | Personal |
| | | | | | | Care - |
| | | | | | | Evonik |
| | | | | | | Industries |
| 1% | 100 | 87 | Cocamide | | 61789- | KAO |
| | | | propyl | | 40-0 | Chemicals, |
| | | | betaine | | | BETADET |
| | | | | | | HR-50K |
| | | | | | | %50 |
| 5% | 500 | 435 | Bis- (2 | | — | Aromox ® |
| | | | hydroxyethyl) | | | T/12 DPM |
| | | | tallowalkyl | | | by |
| | | | amine oxide | | | AkzoNobel |
| | | | | | | Chemicals |
| | | | | | | %40 |
| Sum | 10000 | 9288 | | | | |

Using Sample 1 exotherm stopping mixture and a resin system that consists of 0.5 L of hot melt epoxy, 1.5% diamine catalyst and 5% DICY (dicyandiamide) an experiment held. DICY is used as curing agent. Resin system was heated to 90° C. which is the application temperature of this particular resin system for 30 minutes, after 30 minutes the initial viscosity of the resin doubles which is the time that exothermic reaction may start. To test the effectiveness of exotherm stopping mixture, the resin held at 90° C. for 45 minutes to initiate an exotherm intentionally.

Three different resin mixtures are prepared so that the total volume is 20 L. One of them is control mixture and the second mixture is the one that is stopped by cooling with water. Third one is stopped with Sample 1 exotherm stopper mixture.

Epoxy which is one of the substances that compose the resin is kept in an oven at 90° C. until it melts. Catalyst and curing agent are added into the resin mixture as they are received from suppliers and stirred for 5 minutes. Catalyst and curing agent are added in the resin as masterbatch. Resins are kept in oven at 90° C. for 40 minutes in order to form exotherm. They are taken from the oven without forming any exotherm. Then, they begin to form exotherm in three mixtures at about 50 minutes. The first resin is not interfered. The second one is interfered with water and the third one is interfered with the exotherm stopper mixture disclosed in the invention. Table 3 shows the details and the observations of the process depending on time and temperature.

TABLE 3
Temperature vs time and observations

| | Temperatures of | | |
|---|---|---|---|
| Time (min) | Resin 1 | Temperatures of Resin 2 | Temperatures of Resin 3 |
| 0 | Epoxy compound: | Epoxy compound: 25° C. | Epoxy compound: 25° C. |
| | 25° C. | | |
| | Catalyst | Catalyst masterbatch: | Catalyst masterbatch: |
| | masterbatch: 24° C. | 24° C. | 24° C. |
| | Curing agent | Curing agent masterbatch: | Curing agent |
| | masterbatch: 24° C. | 24° C. | masterbatch: 24° C. |
| 120 | Epoxy component | Epoxy component left for | Epoxy component left |
| | left for 2 hours in the | 2 hours in the oven set to | for 2 hours in the oven |
| | oven set to 95° C. | 95° C. After 2 hours the | set to 95° C. After 2 |
| | After 2 hours the | temperature is 93° C. | hours the temperature is |
| | temperature is 93° C. | | 93° C. |
| | Catalyst masterbatch | Catalyst masterbatch 24° C. | Catalyst masterbatch |
| | 24° C. | | 24° C. |
| | Curing agent | Curing agent masterbatch | Curing agent |
| | masterbatch 24° C. | 24° C. | masterbatch 24° C. |
| 125 | 0.5 L mixture is | 0.5 L mixture is stirred at | 0.5 L mixture is stirred |
| | stirred at 900 rpm | 900 rpm for 5 minutes in 2 | at 900 rpm for 5 |
| | for 5 minutes in 1 5 L | 5 L vessel. After stirring, | minutes in 3 5 L vessel. |
| | vessel. After stirring, | temperature is 82° C. | After stirring, |
| | temperature is 81° C. | | temperature is 81° C. |
| 170 | Resin 1, left for 45 | Resin 2, left for 45 | Resin 3, left for 45 |
| | minutes in the oven | minutes in the oven set to | minutes in the oven set |
| | set to 95° C. After 45 min | 95° C. After 45 min the | to 95° C. After 45 min |
| | the temperature | temperature is 99° C. | the temperature is 95° C. |
| | is 97° C. | | |
| 175 | Resin 1 kept at room | Resin 2 kept at room | Resin 3 kept at room |
| | temperature for 5 min. | temperature for 5 min. | temperature for 5 min. |
| | After 5 min | After 5 min 105° C. | After 5 min 99° C. |
| | 102° C. is measured. | | |
| 180: | Resin 1 kept at room | Resin 2 kept at room | Resin 3 kept at room |
| initiation of | temperature for 5 min. | temperature for 5 min. | temperature for 5 min. |
| exotherm | After 5 min | After 5 min 120° C. | After 5 min 117° C. |
| | 121° C. | | |
| 185 | Resin 1, keep at | Resin 2, keep at room | Resin 3, keep at room |
| | room temperature | temperature for 5 min. | temperature for 5 min. |
| | for 5 min. After 5 min | After 5 min 135° C. | After 5 min 137° C. |
| | 140° C. | | |
| 190: | No interference and | Interfere with 0.5 L water | Interfere with 0.5 L |
| initiation of | 210° C. is measured | 105° C. In this case | exotherm stopper |
| gas output | In this stage, dense | exotherm and gas outlet | 114° C. In this case |
| and | smoke and gas | continues. | exotherm continues. |
| exotherm | output is observed | | Gas outlet is lower than |
| interference | and sound like | | resin 1 and 2. |
| is observed | cracking is heard. | | |
| 195 | 220° C., dense smoke | 104° C., exotherm and gas | 118° C. exotherm |
| | and gas output is | outlet continues. | continues. Gas outlet is |
| | observed and sound | | lower than resin 1 and |
| | like cracking is | | 2. |
| | heard | | |
| 200 | 250° C., dense smoke | 104° C., exotherm and gas | 107° C. exotherm slows |
| | and gas output is | outlet continues, water | down. Gas outlet comes |
| | observed and sound | added at 125^{th} minute | to stopping point; |
| | like cracking is | starts boiling. | exotherm stopper and |
| | heard | | resin are forming a |
| | | | mixture as to form gel. |
| 205 | 282° C., Dense | 130° C. exotherm and gas | 106° C. exotherm slows |
| | smoke and gas | outlet continues. Water | down. Gas outlet comes |
| | output is interfered | evaporates. | to stopping point; |
| | by fire-extinguisher | | exotherm stopper and |
| | and running water in | | resin are forming a |
| | order to prevent a | | mixture as to form gel. |
| | possible fire caused | | |
| | by smoke and gas | | |
| | output. After the | | |
| | interference, mixture | | |
| | forming exotherm is | | |
| | immersing in a | | |
| | barrel full of water. | | |
| 210 | — | 207° C. exotherm | 105° C. exotherm slows |
| | | accelerates, gas outlet | down. Gas outlet comes |
| | | increases water run out | to stopping point; |
| | | from the media. | exotherm stopper and |
| | | | resin are forming a |
| | | | mixture as to form gel. |
| 215 | — | 264° C. | 103° C. exotherm slows |
| | | dense smoke and gas | down. Gas outlet comes |
| | | output is observed and | to stopping point; |
| | | sound like cracking starts | exotherm stopper and |
| | | | resin are forming a |
| | | | mixture as to form gel. |
| 220 | — | 270° C. | 103° C. exotherm slows |
| | | Dense smoke and gas | down. Gas outlet comes |
| | | output is interfered by fire- | to stopping point; |
| | | extinguisher and running | exotherm stopper and |
| | | water in order to prevent a | resin are forming a |
| | | possible fire caused by | mixture as to form gel. |
| | | smoke and gas output. | |
| | | After the interference, | |
| | | mixture forming exotherm | |
| | | is immersing in a barrel | |
| | | full of water. | |
| 250 | — | — | 60° C. no gas outlet |
| 280 | — | — | 34° C. no gas outlet |
| 285 | Cleaning the | Cleaning the container is | Even the mixture of |
| | container is very | very difficult, resin is | exotherm stopper and |
| | difficult because of | solid, dark brown | resin |
| | the calcification and | | adheres to the vessel |
| | carbonization | | surface in places as |
| | | | brown gel, most of it |
| | | | Most of the mixture is |
| | | | distributed in soft sour |
| | | | vinegar-scented gel |
| | | | form |

Sample 2 is directed to understand the effect of exotherm stopper mixture on epoxy-anhydride thermosetting resins. This exotherm stopper mixtures preferably comprises KOH as exotherm stopper reactive. KOH is bind to anhydrides in thermosetting resins and stops the reaction. Surfactants and emulsifiers are used to keep hydrophilic and lipophilic substances in the mixture together. They also provide dispersion of esters that hydrolyzed during exotherm stopping reaction and resulted potassium salt of carboxylic acid in water and solvent. C10-16 Alkyl Polyglycoside and C12/15 8 EO (C12 alkyl 8 ethoxylate and C15 alkyl 8 Ethoxylate mixtures) are preferred surfactants and emulsifiers. Water and diethylene glycol and NMP solvents are preferred high-boiling solvents that are capable of solving the resin are added in order to cool the exotherm, solve the resin and aid to clean.

TABLE 4
2^{nd} sample of exotherm stopper mixture specified
for epoxy-anhydride thermosetting resins

| | | | | | | Brand |
|---|---|---|---|---|---|---|
| | | Volume | | Definition and | | Name |
| Percentage | Weight (g) | (ml) | Substance | ideal amounts | CAS | Supplier |
| 10% | 1000 | Solid | KOH | Exotherm | 1310- | GMA- |
| | | | | Stopper | 58-3 | ALDRICH |
| | | | | reactive, | | Potassium |
| | | | | 5 < x < 15% | | hydroxide |
| 40% | 4000 | 1860 | Diethylene | High-Boiling | 111- | SIGMA- |
| | | | Glycol | Solvents | 46-6 | ALDRICH |
| | | | | 50 < x < 60% | | Diethylene |
| | | | | | | glycol |
| | | | | | | ReagentPlus ®, |
| | | | | | | 99% |
| 19% | 1900 | 1848 | 1-Methyl-2- | High-Boiling | 872- | M6762 |
| | | | pyrrolidinone | Solvents | 50-4 | SIGMA |
| | | | (NMP) | 50 < x < 60% | | 1-Methyl- |
| | | | | | | 2- |
| | | | | | | pyrrolidinone |
| | | | | | | NMP |
| 25% | 2500 | 2500 | Water | Water | — | Deionized |
| | | | | 20 < x < 40% | | |
| 3% | 300 | 261 | C10-16 Alkyl | Excipient | 68515- | Dow |
| | | | Polyglycoside | Mixture | 73-1 | Chemicals, |
| | | | | 3 < x < 10% | | TRITON ™ |
| | | | | | | BG-10 |
| | | | | | | Surfactant |
| | | | | | | %70 |
| 3% | 300 | 261 | C12/15, 8 EO | | 68131- | Schärer & |
| | | | | | 39-5 | Schläpfer |
| | | | | | | AG, Aduxol |
| | | | | | | DB-25- |
| | | | | | | 08 90% |
| Sum | 10000 | 7230 | | | | |

Sample 3 is directed to understand the effect of exotherm stopper mixture on thermosetting resins that give free radical polymerization. This exotherm stopper mixtures preferably comprises KOH, Hydroquinone, Ascorbate, Butylated hydroxyl toluene (BHT) as exotherm stopper reactive. Excipient mixture comprising surfactants, emulsifiers, dispersants or co-solvents or combination thereof are used to keep hydrophilic and lipophilic substances in the mixture together. They also provide dispersion of esters that hydrolyzed during exotherm stopping reaction and resulted potassium salt of carboxylic acid in water and solvent. C10-16 Alkyl Polyglycoside and C12/15 8 EO are used as surfactants, emulsifiers, dispersants and co-solvents. Water and diethylene glycol and NMP solvents as high-boiling solvents are capable of solving the resin are added in order to cool the exotherm, solve the resin and aid to clean.

TABLE 5
3^{th} sample of exotherm stopper mixture specified for
thermosetting resins that give double bond polymerization reaction.

| | | | | | | Brand |
|---|---|---|---|---|---|---|
| | | | | Definition and | | Name |
| Percentage | Weight (g) | Volume (ml) | Substance | ideal amounts | CAS | Supplier |
| 22% | 2200 | 1913 | Xylene | High-Boiling | 1330- | ALDRICH |
| | | | | Solvents | 20-7 | Xylenes |
| | | | | 50 < x < 80% | | reagent |
| | | | | | | grade |
| 19% | 1900 | 1652 | Diethylene | | 111- | SIGMA- |
| | | | Glycol | | 46-6 | ALDRICH |
| | | | | | | Diethylene |
| | | | | | | glycol |
| | | | | | | ReagentPlus ®, |
| | | | | | | 99% |
| 20% | 2000 | 1946 | 1-Methyl- | | 872- | M6762 |
| | | | 2- | | 50-4 | SIGMA |
| | | | pyrrolidinone | | | 1-Methyl- |
| | | | (NMP) | | | 2- |
| | | | | | | pyrrolidinone |
| | | | | | | NMP |
| 10% | 1000 | 1000 | Water | Water | — | Deionized |
| | | | | 5 < x < 15% | | |
| 5% | 500 | 200 | sorbitan | Excipient | 9005- | ALDRICH |
| | | | monolaurate | mixture | 64-5 | Polysorbate |
| | | | (S20) | 10 < x < 20% | | 20 |
| | | | | | | (Solid) |
| 6% | 600 | Solid | Sodium | | 137- | SIGMA |
| | | | Lauroyl | | 16-6 | N- |
| | | | Sarcosinate | | | Lauroylsarcosine |
| | | | | | | sodium |
| | | | | | | salt |
| | | | | | | ≥94% |
| 1% | 100 | 121 | 1-Decanol | | 112- | ALDRICH |
| | | | | | 30-1 | 1-Decanol |
| | | | | | | 99% |
| 1% | 100 | 87 | C12/15, 8 | | 68131- | Schärer & |
| | | | EO | | 39-5 | Schläpfer |
| | | | | | | AG, Aduxol |
| | | | | | | DB-25- |
| | | | | | | 08 90% |
| 1% | 100 | Solid | Imidazoline | | 61791- | Lakeland |
| | | | 18 OH | | 39-7 | Laboratories |
| | | | | | | Limited, |
| | | | | | | IMIDAZOLINE |
| | | | | | | 18OH |
| | | | | | | (%100) |
| 5% | 500 | Solid | Hydroquinone | Exotherm | 123- | SIGMA- |
| | | | | Stopper | 31-9 | ALDRICH |
| | | | | Reactive | | Hydroquinone |
| | | | | 10 < x < 20% | | ReagentPlus ®, |
| | | | | | | ≥99% |
| 5% | 500 | solid | Butylated | | 128- | ALDRICH |
| | | | hydroxytoluene | | 37-0 | Butylated |
| | | | (BHT) | | | hydroxytoluene |
| | | | | | | ≥99%, |
| | | | | | | FCC, FG |
| 5% | 500 | solid | Ascorbic | | 134- | SIGMA |
| | | | Acid or | | 03-2 | (+)- |
| | | | Ascorbate | | | Sodium |
| | | | | | | L- |
| | | | | | | ascorbate |
| | | | | | | crystalline, |
| | | | | | | ≥98% |
| Sum | 10000 | 6918 | | | | |

Sample 4 is exotherm stopper for polyurethane and polyurea thermoset resins. Polyurea and polyurethanes contains either isocyanates or polymeric isocyanates possibly a mixture of both to short stop the step growing polymerization of them high boiling highly reactive point mono functional amines are used for example caprolactam. This exotherm stopper mixtures preferably comprises caprolactam as exotherm stopper reactive. Polyester alcohol surfactants are also used for the same aim and also to facilitate the dispersion of short stopped monomer/oligomer/polymers in solvent/water mixtures. Excipient mixture comprising Surfactants, emulsifiers, dispersants or co-solvents or combination thereof are also needed for the improvement of stability of emulsion of resin in exotherm stopper mixture and also to improve the stability of the exotherm stopper mixtures emulsion itself. Diethylene glycol and NMP are preferred high boiling point solvents and they are added to exotherm stopper mixture to dissolve resin and aid the cleaning of reaction vessel after exotherm. Sample 4 exotherm stopper mixture is prepared by the same method with other samples, Table 6 shows exotherm stopper mixture specified for polyurethane and polyurea thermosetting resins.

TABLE 6
4^{th} sample of exotherm stopper mixture for
polyurethane and polyurea thermosetting resins

| | | | | Definition | | Brand |
|---|---|---|---|---|---|---|
| | | | | and ideal | | Name |
| Percentage | Weight (g) | Volume (ml) | Substance | amounts | CAS | Supplier |
| 20% | 2000 | 1652 | Diethylene | High-Boiling | 111- | SIGMA- |
| | | | Glycol | Solvents | 46-6 | ALDRICH |
| | | | | 30 < x < 70% | | Diethylene |
| | | | | | | glycol |
| | | | | | | ReagentPlus®, |
| | | | | | | 99% |
| 30% | 3000 | 2918 | 1-Methyl-2- | | 872- | M6762 |
| | | | pyrrolidinone | | 50-4 | SIGMA 1- |
| | | | (NMP) | | | Methyl-2- |
| | | | | | | pyrrolidinone |
| | | | | | | NMP |
| 39% | 3900 | 3861 | Caprolactam | Exotherm | 105- | ALDRICH |
| | | | | Stopper | 60-2 | ε- |
| | | | | Reactive | | Caprolactam |
| | | | | 30 < x < 50% | | 99% |
| 5% | 500 | 200 | Sorbitan | Excipient | 9005- | ALDRICH |
| | | | monolaurate | mixture | 64-5 | Polysorbate |
| | | | (S20) | 5 < x < 15% | | 20 |
| | | | | | | (Solid) |
| 3% | 300 | Solid | Sodium | | 137- | SIGMA |
| | | | Lauryl | | 16-6 | N- |
| | | | Sarcosinate | | | Lauroylsarcosine |
| | | | | | | sodium |
| | | | | | | salt |
| | | | | | | ≥94% |
| 1% | 100 | 121 | 1-decanol | | 112- | ALDRICH |
| | | | | | 30-1 | 1-Decanol |
| | | | | | | 99% |
| 1% | 100 | 87 | C12/15, 8 | | 68131- | Schärer & |
| | | | EO | | 39-5 | Schläpfer |
| | | | | | | AG, Aduxol |
| | | | | | | DB-25- |
| | | | | | | 08 90% |
| 1% | 100 | Solid | Imidazoline | | 61791- | Lakeland |
| | | | 18 OH | | 39-7 | Laboratories |
| | | | | | | Limited, |
| | | | | | | IMIDAZOLINE |
| | | | | | | 18OH |
| | | | | | | (%100) |
| Sum | 10000 | 8839 | | | | |

What is claimed is:

1. An exotherm stopper mixture for controlling an exotherm between epoxy-amine thermosetting resins and a hardener, comprising:
water;
at least one high-boiling solvent having a boiling point greater than 100° C. selected from the group consisting of N-Methyl pyrrolidone (NMP), Diethylene Glycol, Xylene, Dimethyl formamide (DMF), Dimethyl acetamide (DMAc), Dimethyl sulfoxide (DMSO) and combinations thereof;
at least one exothermicity stopping reactant selected from the group consisting of sulphamic acid, KOH, caprolactam BHT, hydroquinone, ascorbic acid and combinations thereof wherein the exothermicity stopping reactant forms radical initiators and radical forms by bonding to a curing agent in the epoxy-amine thermosetting resins, intermediate structures formed by the curing agent, and the epoxy-amine thermosetting resins; and
an excipient mixture comprising a surfactant, an emulsifier, a disperser, a co-solvent or a combination thereof.

2. The exotherm stopper mixture according to claim 1, wherein the water accounts for 20-30 vol % of the exotherm stopper mixture.

3. (canceled)

4. (canceled)

5. (canceled)

6. The exotherm stopper mixture according to claim 1, wherein the exothermicity stopping reactant accounts for 30-45 vol % of the exotherm stopper mixture.

7. (canceled)

8. (canceled)

9. (canceled)

10. The exotherm stopper mixture according to claim 1, wherein the high-boiling solvent accounts for 20-30 vol % of the exotherm stopper mixture.

11. (canceled)

12. (canceled)

13. (canceled)

14. The exotherm stopper mixture according to claim 1, wherein the excipient mixture accounts for 5-15 vol % of the exotherm stopper mixture.

15. (canceled)

16. (canceled)

17. (canceled)

18. The exotherm stopper mixture according to claim 1, wherein the surfactant is a hard duty surfactant.

19. The exotherm stopper mixture according to claim 1, further comprising at least one antimicrobial agent.

20. The exotherm stopper mixture according to claim 19, wherein the antimicrobial agent accounts for 0-5 vol % of the exotherm stopper mixture.

21. (canceled)

22. The exotherm stopper mixture according to claim 1, wherein the high-boiling solvent is a diethylene glycol.

23. (canceled)

24. (canceled)

25. (canceled)

26. (canceled)

27. (canceled)

28. The exotherm stopper mixture according to claim 1, wherein the exothermicity stopping reactant is an acetic acid and/or a sulphamic acid.

29. (canceled)

30. (canceled)

31. (canceled)

32. The exotherm stopper mixture according to claim 1, wherein the excipient mixture is selected from the group consisting of cetrimonium chloride, bis-(2 hydroxyethyl) tallow alkyl amine oxide, cocamide propyl betaine, C10-16 alkyl polyglycoside, C12/15 8 EO, sorbitan monolaurate (S20), Sodium Lauryl Sarcosinate, 1-Decanol, and imidazoline 18 OH.

33. The exotherm stopper mixture according to claim 1, wherein the surfactant, the emulsifier, the dispersant, the co-solvent or the combination thereof is selected from the group consisting of cetrimonium chloride, bis-(2 hydroxyethyl) tallow alkyl amine oxide and/or cocamide propyl betaine.

34. (canceled)

35. (canceled)

36. (canceled)

37. (canceled)

38. (canceled)

39. (canceled)

40. A method of controlling an exotherm between epoxy-amine thermosetting resins and a hardener, wherein the exotherm stopper mixture according to claim 1 is added to the epoxy-amine thermosetting resins, and the exotherm stopper mixture is at least twice the volume of the epoxy-amine thermosetting resins that form the exotherm.
